(19) United States
(12) Patent Application Publication
(10) Pub. No.: US 2013/0313344 A1
(43) Pub. Date: Nov. 28, 2013

(54) PROCESS FOR RECOVERING BITUMEN FROM ROOFING WASTE

(71) Applicants: Yuriy Nykulin, Toronto (CA); Yulia Gordeeva, Vaughan (CA); Vyacheslav Zheleznyakov, Richmond Hill (CA)

(72) Inventors: Yuriy Nykulin, Toronto (CA); Yulia Gordeeva, Vaughan (CA); Vyacheslav Zheleznyakov, Richmond Hill (CA)

(21) Appl. No.: 13/864,480

(22) Filed: Apr. 17, 2013

(30) Foreign Application Priority Data
Apr. 18, 2012 (CA) 2774984

(51) Int. Cl. B02C 23/08; B02C 19/00; B02C 23/18; B02C 19/18

(52) U.S. Cl. CPC B02C 23/08; B02C 19/186; B02C 19/0056; B02C 23/18
USPC 241/17; 241/24.1; 241/68; 241/38

(57) ABSTRACT

Collected roofing waste, derived on-stream of old roof renovation process, exposure cold grinding with sequential separation to extract layers of bitumen from old roofing membrane. Extracted bitumen layers in crumbs are subjected to thermo dehydration and recovering by injection of volatile and modifier compounds.

### FIELD OF THE INVENTION

This invention pertains to a recovery of bitumen from a recycled asphalt based roof scraps, acquired in process of replacement of commercial and residential flat and low slope roof systems.

### BACKGROUND OF THE INVENTION

The Canadian industrial and commercial low-slope roofing market uses a vast array of roofing products and systems. There are conventional roofs and protected membrane roofs, single ply roofs and multiple ply roofs, comprising numerous types of membranes and built-up roof systems. Roofing asphalt or bitumen is utilized in several types of roof systems including: traditional four-ply built-up roofs, two-ply modified bitumen roofs and rubberized asphalt roof. Modified bitumen and asphalt built-up roof systems combined account for as much as 80% of the annual Canadian low slope roofing market. The recent Canadian Roofing Contractors' Association estimates that Canadian commercial roofing sector sales approach $1.6 billion on an annual basis. The CRCA estimates that the roof replacement accounts for approximately 60% of all roofing works activity. As result, it was estimated that about 330,000 tonnes of asphalt containing roofing scrap being produced by the roofing sector annually, while the re-roofing accounts for about 99% of the total waste stream.

Potential use markets identified for residential and commercial asphalt roofing scrap are currently: hot-mix asphalt and cold patch, dust control on countryside roads and temporary roads, driveways and parking lots, aggregate base and fuel.

Current processes for roof material recycling include crushing the material into a homogeneous mix. This mix can be used as a filler as is. Ultimately it can be used to generate pure bitumen through thermo-mechanical separation, such as melting the bitumen and squishing it from the mix through a finely porous membrane. This process is expensive and in many cases not economically feasible.

Additional issue with the roofing in North America is a use of gravel and stones, compounded with the top layer of Build-Up roof and use as protection from ultraviolet impact. The current crushing and separating techniques are not adapted to work with mix of bitumen, paper and stones.

In Canada, asphalt based roofing scrap has been incorporated in hot-mix asphalt, trail construction and as a fuel in cement kilns. Some provinces (Ontario and Nova Scotia) have provisions for using up to 5% of recycled asphalt shingles in a hot-mix asphalt production. It is estimated that there are over 500 hot-mix asphalt plants across Canada producing in the order of 30 to 31 million tonnes annually. Substitution of even 5% of the virgin material in hot-mix asphalt could consume in the order of 1.5 million tonnes of asphalt roofing scrap generated in Canada annually. Further, it is estimated that a substituting of even 5% roofing scrap for virgin asphalt concrete would eliminate 90,000 tonnes of greenhouse gases produced by the hot-mix asphalt industry.

The benefits of recycling asphalt based roofing products include conservation of landfill space and resources, reduced costs of disposal, and lower costs of production as compared to new roofing products made from virgin materials.

Therefore there is a need for an improved process for recovering asphalt from the roofing scraps, to reduce an environmental impact of the construction waste and also to save on resources in manufacturing of hot-mix asphalt products.

### SUMMARY OF THE INVENTION

This invention pertains to a recovery of bitumen from a recycled asphalt based roof scraps, acquired in process of replacement of commercial and residential flat and low slope roof systems.

The present invention is based on the discovery that when bitumen roof assembly become deteriorated as effect of weather impact it actively absorbs atmospheric moisture. This moisture, entrapped inside layers of bitumen and roofing felt makes the layered materials more fragile and prone to fracturing. After an extensive research it was found that this phenomenon, can be used for assisted separation of the bitumen from the surrounded materials by crushing with hitting and hammering. This separation is possible because the “old moisture-laden bitumen” ceases to be effective bonding material for layers of roofing felt, thus promoting fracturing.

This mechanical separation by breaking allows recovering high amount of bitumen from the recycled material with lower capital and operational costs.

Following the mechanical fracturing/breaking, a separation, dehydration and recovery processes make it possible to regenerate a substantial amount of bitumen for secondary use.

Therefore, one aspect of the invention is a use of a cold separation process for separating bitumen from roofing scrap materials. Following the cold separation process, purification and regeneration of bitumen, allows use of this bitumen in a wide range of application of bituminous materials for renovation and restoration roof and other systems.

According to one aspect of the invention, in the cold bitumen extracting process, the mix of torn off old roofing materials is preliminarily sorted with bitumen roofing membrane abjection and periodically loaded to continuously working horizontal cylinder-shaped rotor type impact extractor. In the extractor, material is exposed to additional impact grinding with splitting off layers of bitumen from felt base. Further, the generated mix consisted from split bitumen crumbs, roofing felt chips and gravel continuously moved into wire mesh equipped drum separator. Result of separation process is the making of homogeneous mix, consisted from bitumen crumbs. Batch of bitumen crumbs are loaded to heat reactor and underwent thermo dehydration under temperature of 60-250 C.°, preferably 160-200 C.° more preferably about 180° C. During dehydration process liquid bitumen is periodically mixed and recovered by injection of volatile and modifier compounds known in the art to add elasticity and reduce melting point of the bitumen.

The improvement further comprising a method to recycle torn off asphalt/bitumen based old roofing scrap material whereby described above double-stage low temperature process with recovering secondary bitumen for further using at roofing, constructions, roads and other applications.

Preferably the preliminary chopped roofing materials are being separated into bitumen crumbs and bitumen saturated roofing felt chips in the cylinder-shaped rotor type impact extractor. The impact extractor consists of rotating cylinder capable of rotation with 400-600 rpm. Said cylinder is being equipped with a plurality of hitting elements such as teeth of hammers. Cylinder has preferably about 20-30 sized 4″×4″ non-sharped impact teeth. The size and geometry of these teeth may be adapted to the apparatus; also the number of such teeth per cylinder may vary. The teeth are preferably non-sharped, thus they provide mostly hitting/crushing/grinding destructive action. Preferably these teeth are not cutting the material.

However in an alternative embodiment a cutting devise also can be utilized.

In an alternative embodiment the extractor can be equipped with additional destructive features known in the art such as vibrating and/or ultrasonic features.

According to another aspect of the invention, the preliminary chopped, separated and averaged bitumen crumbs mix underwent thermo dehydration in preferably vertical type oil-jacketed reactor equipped with a heating system with temperature interval 60-250° C., equipped with mechanical agitator and tap-holes to separately release recovered secondary bitumen and the bitumen fouled with mineral slurry.

According to further aspect of the invention, after the separation, roofing felt chips comprising bitumen, paper are underwent thermo dehydration in a vertical type oil-jacketed reactor equipped with a heating system with temperature interval 60-250° C. with simultaneous mixing and smoothing in hot condition. This mixture can further be used to produce various bituminous core products to use in roofing and waterproofing applications, such as the bituminous mineral core board for torch down roofing application and bituminous mastics for cold processing in roofing and waterproofing applications.

According to yet another aspect of the invention there is provided a method for recycling asphalt based roofing material; the process comprises a cold mechanical crushing of the roofing material by impact, and separating said crushed material by a mechanical separation, into a first mix material comprising mostly bitumen and a second mix material comprising bitumen, felt and gravel.

Preferably, first mix material is further purified by dehydration, mixed with volatile and modifying compounds and gravity separated to mostly generate secondary bitumen which can be reused in the industry.

Preferably, the second mix material is further purified by dehydration, milled, and mixed with volatile and modified compounds to generate a bitumen-wood fiber mix.

Still preferably, the mechanical crushing of the asphalt based roofing material, being conducted in a cylinder-shaped rotor type impact extractor, comprising a rotational cylinder equipped with a plurality of non-sharpen impact members and a separating sieve.

According to another aspect of the invention there is provided an apparatus for cold separation of recycled asphalt based roofing material, said apparatus comprises a cylinder-shaped rotor type impact extractor with a rotational cylinder, equipped with a plurality of non-sharpen impact members and a separating sieve. Preferably, the separating sieve has a plurality of openings of about ¾″ while the apparatus is further comprising a mist generator. More preferably, said apparatus is further equipped with a separation drum and an air separator to separate said material into a first mix material comprising fine bitumen particles, a second mix material comprising bitumen particles with wood chips and third coarse mix material comprising gravel.

According to yet another aspect of the invention there is provided a method for recovering bitumen from a recycled asphalt based roofing material, the method comprising: utilizing the apparatus for cold separation listed above, to separate the first mix material from the recycled asphalt based roofing material, thermo-dehydrating said first mix material in thermal reactor, enriching said dehydrated mix with volatile compounds selected from the group of: organic and synthetic oil base materials and modifying compounds selected from the group of styrene-butadiene-styrene polymers, and gravity separated from the secondary grade bitumen.

According to yet another aspect of the invention there is provided a method for generating bitumen felt mix, from a recycled asphalt based roofing material, the method comprising: utilizing the apparatus for cold separation listed above, to separate the second mix material from the recycled asphalt based roofing material, thermo-dehydrating said second mix material in thermal reactor, enriching said dehydrated mix with volatile compounds selected from the group of: organic and synthetic oil base materials and modifying compounds selected from the group of styrene-butadiene-styrene polymers, while milling it through siefer mill.

Further there is provided a process for recovering bitumen from a recycled asphalt based roofing material, the process comprising: utilizing the cold separation apparatus to separate the first mix material from the recycled asphalt based roofing material, thermo-dehydrating said first mix material in thermal reactor, enriching said dehydrated mix with volatile compounds selected from the group of: organic and synthetic oil base materials and modifying compounds selected from the group of styrene-butadiene-styrene polymers, and gravity separated from the secondary grade bitumen. Preferably, the thermo-dehydration process takes place in thermal reactor with agitation in the temperature range of 60-250°, preferably 160-200 C.°, more preferably at about 18° C.°

According still another aspect of the invention there is provided a process for generating bitumen felt mix, from a recycled asphalt based roofing material, the process comprising: utilizing the apparatus for cold mechanical separation mentioned above, to separate the second mix material from the recycled asphalt based roofing material, thermo-dehydrating said second mix material in thermal reactor, enriching said dehydrated mix with volatile compounds selected from the group of: organic and synthetic oil base materials and modifying compounds selected from the group of styrene-butadiene-styrene polymers, while milling it through siefer mill. Preferably, the thermo-dehydration process takes place in the thermal reactor with agitation in the temperature range of 60-250°, preferably 160-200 C.°, more preferably at about 180° C.

These and other aspects of the invention would be provided description, examples and the claims.

### DESCRIPTION OF THE DRAWINGS

FIG. 1 is a schematic diagram that describes a recycling process of old roofing materials.

FIG. 2 is a schematic representation of first embodiment of a horizontal cylinder-shaped rotor type impact extractor.

FIG. 3 is a schematic representation of a second type of horizontal cylinder-shaped rotor type impact extractor to carry out extraction of bitumen from preliminary chopped roofing materials.

FIG. 4 is schematic representation of first embodiment vertical type oil-jacketed, heated reactor, equipped with agitator and tap-holes to separate release recovered secondary bitumen and mineral residue.

FIG. 5 is schematic representation of second embodiment of vertical type oil-jacketed, heated reactor, equipped with agitator and tap-holes to separate release recovered secondary bitumen and mineral residue.

### DETAILED DESCRIPTION OF THE PREFERRED EMBODIMENT

The process for recycling roof material comprises several separation, purification and recovery processes. First the materials are being separated to bitumen comprising materials and other rejected materials. The bitumen containing materials are mechanically separated into bitumen crumbles and soaked with bitumen roofing felt. Each of these materials flows further dehydrated and purified to generate products useful in future applications. Such as commercial grade bitumen, bitumen emulsion and bitumen fiber mix.

One of the aspects of the invention is the cold separation of the recycled materials unlike the method used in the art; the material should not be milled to the homogeneous mix. The recycled material should be cut into relatively large pieces and these pieces should be mechanically destroyed by crashing, hitting, hammering, with or without assistance of the vibration. This way there is an increased chance that bitumen particles would be fully separated from the paper layers. This crashing by hitting should be differentiated from simple crashing by cutting. Since hitting would solve the problem of separation of bitumen from the paper. Therefore the hitting apparatuses preferably have no sharp members, to reduce the chance of cutting material.

In alternative embodiment the separation apparatuses may comprises combination of hitting, crushing and cutting members.

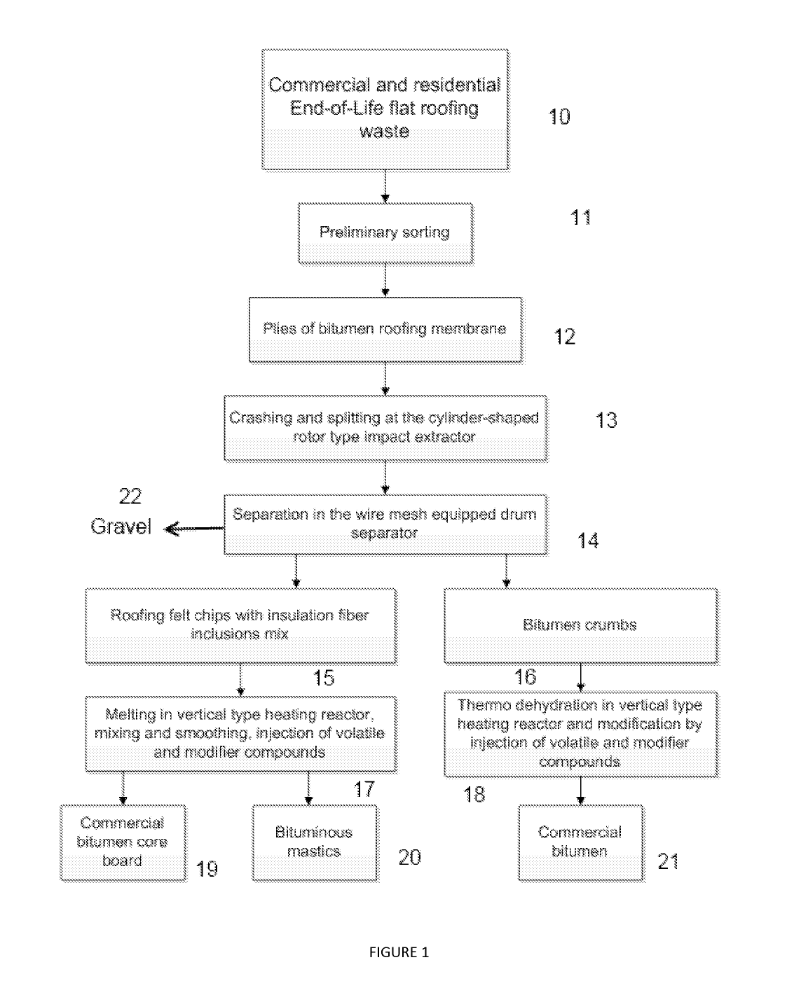

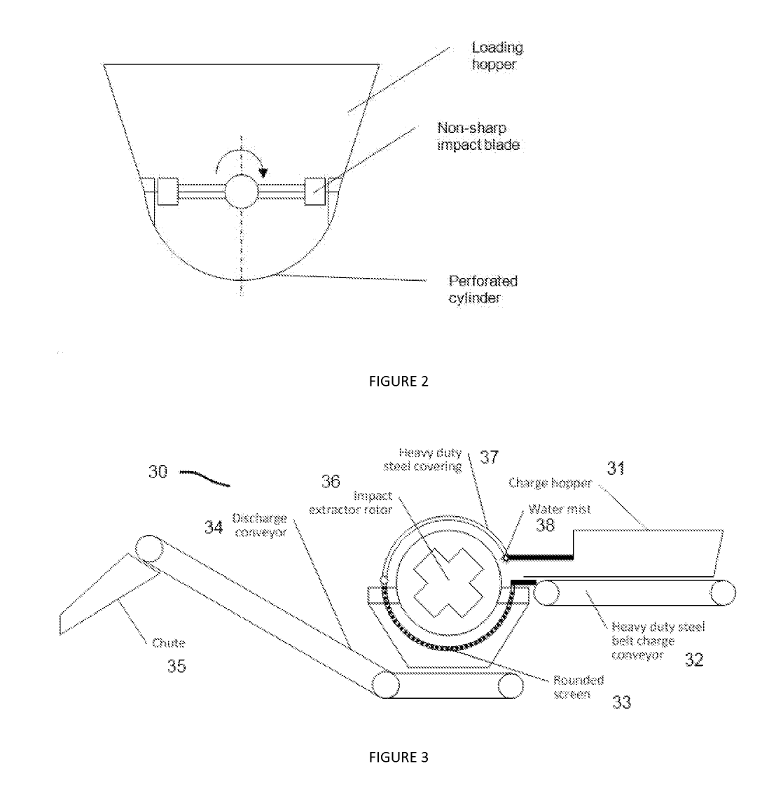

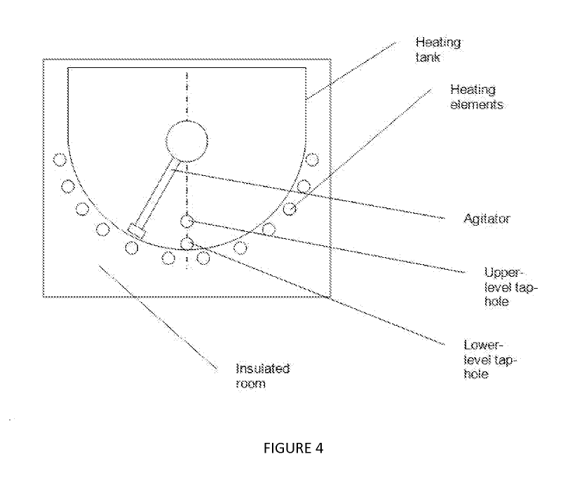

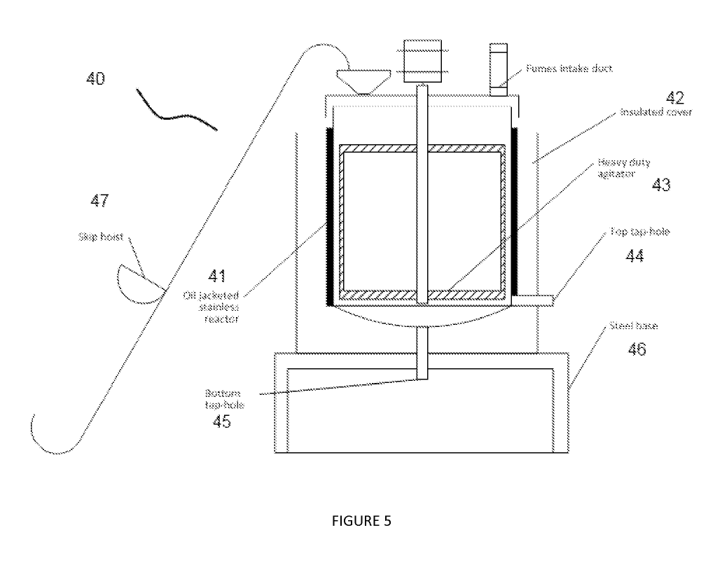

The invention being illustrated by the example set below. The data for this example was developed in the following manner, using the diagram in FIG. 1. FIGS. 2 and 3 schematically illustrated apparatuses used for cold mechanical crushing of the roofing material. FIGS. 4 and 4 and 5 schematically illustrate thermal reactors. It would be apparent to the person skilled in the art that other apparatuses can be used to perform these functions.

During a roof replacement, old roof was cut by segments with approximate size 3′×3′ (10). Further roofing membrane torn off and were sorted (11) by splitting the bituminous layers from the rigid wood fiber insulation. The bituminous roofing scraps were collected into a waste container and transported to outside storage for further reprocessing (12).

Cold Separation Step (12-16 in FIG. 1)

Ready for reprocessing main roofing bituminous membrane, comprising plies of roofing felt physically stuck together with mopped bitumen and compounded with the top layer of membrane gravel, was mechanically loaded into charging hopper and continuously fed into a horizontal cylinder-shaped rotor type impact extractor (13). The impact extractor (30) illustrated in FIG. 3 consists of a cylinder (36) rotated with 500 rpm, comprising 20 appropriate sized non sharped impact teeth. During the extraction, the milled material was removed from the extractor out through screen (33) through a plurality of apertures with diameter ¾″, positioned at the bottom part of the extractor (30). This extracted milled mix comprises bitumen crumbs, roofing felt chips and gravel. To prevent balling of bitumen onto the rotated parts, the impact extractor was equipped with a mist generating nozzles, spraying regular cold water into the extractor system.

After exiting the rotor-type impact extractor, the resulting mix, comprises bitumen crumbs, roofing felt chips and gravel was continuously moved into through conveyor (34) to a drum separator. Drum separator is equipment well known in the art. Said drum separator (14) was equipped with steel wire mesh with apertures of ⅛″, allows separating most of the bitumen crumbs as a First type of material (16) from the loaded milled mix. Second type of materials, witch size was bigger than ⅛″, consist of bitumen felt chips and gravel mix, was continuously removed from the drum separator through the end face. This second type of materials was exposed to a gravitational separation along with pressured air separation. This double separation was conducted to split the roofing felt chips (15) as the light ends and the gravel (22) as the tailing.

As the results of cold separation step, there were acquired three types of segregated materials: First mix (16) of bitumen crumbs fraction smaller than ⅛″, which was used in manufacturing of commercial bitumen. Second mix (15) Bitumen felt chips with size above ⅛″, which was used to produce various bituminous core products, for example to use in roofing and waterproofing applications. And commercial gravel fraction with size of about ⅜″-⅝″, that was can be used as-is in road, roofing and construction applications. Separated materials were stockpiled in different piles ready for further processing.

Dehydration Step (18)

The bitumen crumbs, the first type of products acquired from cold separation step, were mechanically loaded into a vertical type stainless steel oil-jacketed Mueller reactor Illustrated in FIG. 5 with working volume equivalent to about 2000 US Gal. The reactor (40) was equipped with an isothermal gas heating system (41) with temperature range of 60-250° C., a heavy duty mechanical agitator (43) and tap-holes (44) and (45). The reactor (40) was used to regenerated and separated release recovered bitumen and residual bitumen fouled with mineral slurry.

The mass of loading batch depends on a capacity of reactor to be used. Process of dehydration was started at temperature of about 180° C. with an intensive mechanical agitation and was conducted with foaming of the liquid bitumen. The agitator was periodically changed rotation from clockwise to counter clockwise. Intensity of the agitation in that period was corresponded to about 30 rpm. Process of dehydration was continued until the majority of water was removed. The end point of dehydration process was visually indicated by discontinue of foaming and sudden increase in the temperature of liquid bitumen that was produced, along with appearing of white smoke. At this point of time the reactor was ready to receive next batch of the bitumen crumbs.

Intensive mechanical agitation and temperature of 180° C. were sustained during the full dehydration of loaded volume of bitumen crumbs. The temperature settings were adapted to a working volume of the reactor.

Bitumen Recovery

When the maximum loading of the reactor was reached and dehydration process was completely finished, the liquid bitumen was further recovered by an injection of volatile and modifier compounds. In this example we used crankcase oil however any organic and synthetic oil base materials can be used as a volatile compound. The use of rejected oil was one of examples of further reduction of environmental impact. The volatile compound was injected in the range of about 4% by weight of loaded bitumen crumbs. SBS modification pellets were used as a modifier compound. Actually any modifying compound known in the art can be used for example any styrene-butadiene-styrene polymer group even recycled plastic bags can be used as modifying agent. The SBS modification pellets were loaded into liquid bitumen in about 2% by weight from loaded bitumen crumbs.

After bitumen was recovered the agitation was continued for about 1 hour in order to acquire fully homogenous recovered bituminous solution. After 1 hour the intensity of the mechanical agitation was reduced to 10 rpm, the temperature was gradually to 70° C. in about 2 hours.

The recovered bitumen was maintained in the reactor at a temperature of about 70° C. without mechanical agitation, to allow the fouled bitumen with mineral slurry to settle to the bottom of the reactor.

Consecutively, the substantially clean liquid bitumen (21) also known as secondary bitumen were collected from the reactor using an upper level tap-hole (44) for packaging, or later processing. The residual of the fouled bitumen, along with mineral slurry, was removed from the reactor through low level tap-hole (45) and after crystallization was stockpiled for further processing. There was a low amount of fouled bitumen, since the main compound of first mix was bitumen crumbles.

Secondary Product Recovery (17)

Soaked bitumen roofing felt chips with size of above ⅛″, that were derived as a second type of products from the cold separation step, were mechanically loaded into a to vertical type stainless steel oil-jacketed Mueller reactor with working volume equivalent 2000 US Gal. The reactor was equipped with an isotherm gas heating system with working temperature interval of about 60-250° C., heavy duty mechanical agitator and tap-holes to release bitumen mix. The mass of loading batch depends on capacity of reactor to be used.

The process of dehydration was started at a temperature of about 180° C. with intensive mechanical agitation and was conducted with foaming of the liquid bitumen. The agitator periodically changed rotation from clockwise to counter clockwise. Intensity of the agitation in that period was corresponded to about 30 rpm. Process of dehydration was continued until the majority of water was removed, that was visually indicated by halt of foaming and sudden increase of the temperature of liquid bitumen that was conducted, along with appearing of white smoke.

At this time the reactor was ready to load next batch of the bitumen felt chips. Intensive mechanical agitation and temperature of 180° C. was sustained during full dehydration of loaded volume of bitumen felt chips. The temperature profile was adapted to the working volume of the reactor.

When the maximum load of the reactor was reached and dehydration process was completely finished, the liquid bitumen mix was milled and smoothed by continuously pumping through siefer mill, simultaneously with injection of volatile and modifier compounds. Used/recycled crankcase oil was used as a volatile compound and was injected in about of 3%-5% from loaded bitumen felt chips. SBS modification pellets were used as a modifier compound and were loaded to liquid bitumen/felt mixture in term of numbers of 1%-3% from loaded bitumen felt chips. After bitumen mix was recovered the agitation was continued for about 1 hour for the purpose to acquire fully homogenous bituminous-wood fiber solution. The recovered bitumen-wood fiber mix was used to produce various bituminous core products (19) to use in roofing and waterproofing applications. The mix can also be used to produce Bituminous Mastics (20).

The Table below roughly illustrates the mass balance of the process in the example. All numbers are provided in kg. This way a significant amount of secondary bitumen was recovered from the recycled roof material. The recovery rate of bitumen was almost 50% of the initial weight, and more than 80% of the bitumen was recovered. Many variations and improvements can be made to the current process to further improve these numbers.

| | Cold separation step | | | | | |
|---|---|---|---|---|---|---|
| Torn off and | | Soaked | | Dehydration and recovery step | | |
| preliminary sorted | | bitumen | | | Mineral | bitumen-wood |
| bituminous | Bitumen | roofing | | | fouled | fiber |
| membrane | crumbs | felt chips | Gravel | Bitumen | bitumen | mix |
| 1000 | 450 ÷ 550 | 150 ÷ 250 | 300 kg | 400 ÷ 500 | 20 ÷ 30 | 150 ÷ 250 |

It would be apparent to the person skilled in the art that many modifications can be made to the disclosure without departing from the scope of the invention. Thus provided examples are presented as a sample and not in a limiting way.

We claim:

1- A method for recycling asphalt based roofing material; the process comprises a mechanical crushing of the roofing material by impact, and separating said crushed material by a mechanical separation, into a first mix material comprising mostly bitumen and a second mix material comprising bitumen, felt and gravel.

2- The method of claim 1 wherein first mix material is further purified by dehydration, mixed with volatile and modifying compounds and gravity separated to generate secondary bitumen.

3- The method of claim 1 wherein the second mix material is further purified by dehydration, milled, and mixed with volatile and modified compounds to generate a bitumen-wood fiber mix.

4- The method of claim 1 wherein the mechanical crushing of the asphalt based roofing material, being conducted in a cylinder-shaped rotor type impact extractor, comprising a rotational cylinder equipped with a plurality of non-sharpen impact members and a separating sieve.

5- An apparatus for cold separation of recycled asphalt based roofing material, said apparatus comprises a cylinder-shaped rotor type impact extractor with a rotational cylinder, equipped with a plurality of non-sharpen impact members and a separating sieve.

6- The apparatus of claim 5 wherein the separating sieve has openings of about ¾″while the apparatus is further comprising a mist generator.

7- The apparatus of claim 6 further equipped with a separation drum and an air separator to separate said material into a first mix material comprising fine bitumen particles, a second mix material comprising bitumen particles with wood chips and third coarse mix material comprising gravel.

8- A method for recovering bitumen from a recycled asphalt based roofing material, the method comprising: utilizing the apparatus of claim 7 to separate the first mix material from the recycled asphalt based roofing material, thermo-dehydrating said first mix material in thermal reactor, enriching said dehydrated mix with volatile compounds selected from the group of: organic and synthetic oil base materials and modifying compounds selected from the group of styrene-butadiene-styrene polymers, and gravity separated from the secondary grade bitumen.

9- A method for generating bitumen felt mix, from a recycled asphalt based roofing material, the method comprising: utilizing the apparatus of claim 7 to separate the second mix material from the recycled asphalt based roofing material, thermo-dehydrating said second mix material in thermal reactor, enriching said dehydrated mix with volatile compounds selected from the group of: organic and synthetic oil base materials and modifying compounds selected from the group of styrene-butadiene-styrene polymers, while milling it through siefer mill.

10- A process for recovering bitumen from a recycled asphalt based roofing material, the process comprising: utilizing the apparatus of claim 7 to separate the first mix material from the recycled asphalt based roofing material, thermo-dehydrating said first mix material in thermal reactor, enriching said dehydrated mix with volatile compounds selected from the group of: organic and synthetic oil base materials and modifying compounds selected from the group of styrene-butadiene-styrene polymers, and gravity separated from the secondary grade bitumen.

11- The process of claim 10 wherein the thermo-dehydration process takes place in thermal reactor with agitation in the temperature range of 60-250°, preferably 160-200 C.°, more preferably at about 18° C.°.

12- A process for generating bitumen felt mix, from a recycled asphalt based roofing material, the process comprising: utilizing the apparatus of claim 7 to separate the second mix material from the recycled asphalt based roofing material, thermo-dehydrating said second mix material in thermal reactor, enriching said dehydrated mix with volatile compounds selected from the group of: organic and synthetic oil base materials and modifying compounds selected from the group of styrene-butadiene-styrene polymers, while milling it through siefer mill.

13- The process of claim 12 wherein the thermo-dehydration process takes place in the thermal reactor with agitation in the temperature range of 60-250°, preferably 160-200 C.°, more preferably at about 18° C.°.
